(19) United States
(12) Patent Application Publication
(10) Pub. No.: US 2006/0027679 A1
(43) Pub. Date: Feb. 9, 2006

(54) Ejector Nozzle

(75) Inventor: Jack Edward Gratteau, Morgan Hill, CA (US)

Correspondence Address: JACK EDWARD GRATTEAU, 17147 TASSAJARA CIRCLE, MORGAN HILL, CA, 95037, US

(73) Assignee: Mr. Jack Edward Gratteau, Morgan Hill, CA (US)

(21) Appl. No.: 10/710,798

(22) Filed: Aug. 3, 2004

(51) Int. Cl. B05B 1/28; B05B 1/14; B05B 7/08; A62C 2/08

(52) U.S. Cl. 239/291; 239/548; 239/549; 239/290

(57) ABSTRACT

A multi-lobed ejector nozzle of economical construction and simple form is described. The lobes are formed by a plurality of short tubes that intersect with a central jet. Coanda jets upstream of the ejector formed by a collar and multiple apertures further assist the induction of an external flow to the primary ejector. Shaping of the tube nozzles aid in forming the ejector lobes. The nozzle geometry and the Coanda ring contribute to a reduction in the noise of the ejector assembly.

### BACKGROUND OF INVENTION

An ejector nozzle is a device that couples the jet flow of a primary fluid stream with a surrounding fluid, inducing a flow in that fluid. These fluids may be liquids, gas, slurries, or mixtures of both. Ejector nozzles vary in complexity from a simple pipe, to complex geometries as may be useful for noise or efficiency.

Common to most nozzles is a convergent section of the primary flow about which the secondary flow is drawn into by the suction effect of the core fluid stream. It has been found that the efficiency of an ejector nozzle can be improved by structuring the flow into multiple lobes about a common jet. The multiple lobes increase the surface area of the jet stream, while the convergent section maintains a high velocity in the jet.

Air breathing jets, hydraulic jet pumps, and mixers are common applications that employ ejector type nozzles. The operating environment places restrictions on what materials and fabrication methods may be applied. In jet aircraft, these structures are subject to high pressures and temperatures. Jet pumps and mixers may need to operate in corrosive or abrasive media.

Jet engines have long employed corrugated structures such as that seen in U.S. Pat. No. 3,592,291. An important feature of this design are the ports that allow upstream air to mix with core jet in a manner that reduces noise. At the extreme efficiency end of the design spectrum, U.S. Pat. No. 6,082,635 makes extensive use of contoured shapes and exotic fabrication methods. A more conventional form of a corrugated ejector can be seen in U.S. Pat. No. 4,196,585. Midway between these two forms is exemplified in U.S. Pat. No. 4,543,784. Another important design example is U.S. Pat. No. 6,360,528 B1, which notches the trailing edge of the nozzle for sound suppression effects. The feature is not un-like the silent feathering of Owls, and is common on low noise fan blades (ref U.S. Pat. No. 4,089,618). The '635 patent also discloses the merits of chevron shapes in the nozzle tip to reduce noise.

Hydraulic jet pumps predate the thrust augmentation described here. The use of the term ejector in the application dates at least as far back as U.S. Pat. No. 277,072. A cruciform nozzle can be seen in the steam cleaner of U.S. Pat. No. 465,590.

For hydraulic applications in a corrosive or abrasive regimen, folded structures like that that used in gas turbines are limited by materials compatibility that can be so formed. For lesser applications in small gas turbines, the expense of the nozzle and related components impede the broader adoption of ejector technologies.

### SUMMARY OF INVENTION

The object of this design is to enable the construction of an efficient ejector using stock available shapes and simple fabrication methods. The resulting component can be made out of a wide variety of materials and formed as needed to the application.

A convergent conical shape is the foundation for the nozzle construction. Around this cone, several tubes are affixed such that the tubes have clearance from each adjacent neighboring tube. The inlet end of the tubes are cut at an angle so that tubes intersect with the conic section at a shallow angle, and the exit of the tube converges at the tangent of the main exit flow path. The tubes can be welded, glued, or fastened as appropriate for the material and application. The tube can then be used to guide the fabrication of a passage into the conic section. The passage so created has a very large surface area in respect to the tube diameter, with the result that the combination behaves as a convergent nozzle.

At the upper inlet end of where the tubes intersect with the main conic section, the space between the tubes is large. Into this space auxiliary flow passages are formed. The flow from the auxiliary passages is directed at a collar mounted around the tubes at the resulting circumference. The collar then deflects the flow down stream.

The collar then behaves as a Coanda injector. Part of the exterior volume upstream from collar is drawn into space between the collar and the main conical nozzle. This flow is then further ejected down stream from the collar to the primary ejector nozzle region.

The exit ends of the tubes that surround the main nozzle can be shaped to form a fan discharge pattern radial to the core flow path. The tube end could be squeezed to form a more narrow flow passage, or cut at an angle away from the flow path. With the tubes exit ends cut at angle, the noise of the ejector can be reduced over that of a simple blunt cut orifice.

### BRIEF DESCRIPTION OF DRAWINGS

The basic form of the preferred embodiment is shown in four views. The means to attach the tubes is not shown as it not material to this patent. Those skilled in the art can weld, glue, fasten, mold, or otherwise fabricate the shape here described.

FIG. 1 is an off-axis view that shows the nozzle assembly from the perspective of the exit end.

FIG. 2 is plan view of the right hand side.

FIG. 3 is a section of FIG. 2 as indicated by section line 3-3.

FIG. 4 is a section of FIG. 3 as indicated by section line 4-4.

### DETAILED DESCRIPTION

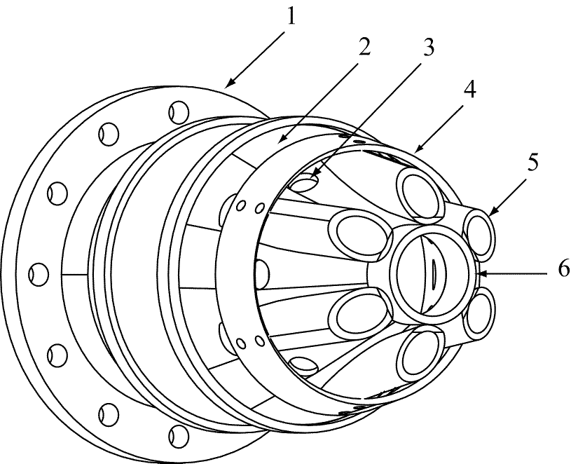

The nozzle assembly depicted in FIG. 1 is an off-axis view from the perspective of the ejector jet exit. The inlet flange 1 is intended to illustrate any generic means to couple the jet nozzle to the source of supply. The convergent cone 2 then conveys the motive fluid to the primary central jet, which in this example is terminated by a short tube 6.

Around the cone 2 are disposed a plurality of tubes 5 that intersect with the cone 2 and converge with the primary jet 6. The tubes 5 are arranged around the primary jet 6 such that there is space between each tube 5 exit. The inlet of the tubes 5 are cut at an acute angle at the plane of the surface of cone 2 to affix the tubes 5 to the cone 2 as described.

Proximal to the inlet end of the tube 5 bundle a collar 4 is disposed at that circumference. Underneath the collar 4, passage holes 3 penetrate the convergent nozzle 2. The passage holes 3 could be any number or shape as needed. The collar 4 could be circular or polygonal in shape about tubes 5.

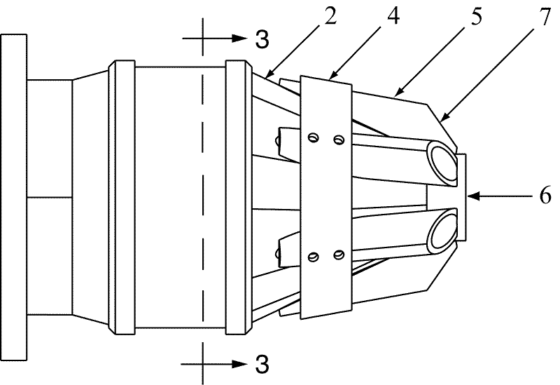

The relationship of the collar 4 and the tube 5 assembly is shown in the plan view of FIG. 2. The auxiliary passage holes 3 are hidden behind the collar 4. The tubes 5 are shown with blunt trimmed ends to facilitate welding, as that is the preferred means of fabricating the structure, but not the only means. The tubes and collar are fastened by any means compatible with the material and application.

An optional fabrication treatment of the tubes 5 is the cutting of the exit end 7 at an angle radially from the main axis of the nozzle assembly. The end of the tube 5 could be bent or formed as desired to alter the geometry of the jet lobe emitted from the tube 5.

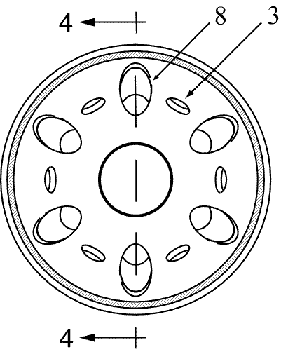

Section line 3-3 creates the detail view of FIG. 3, looking into the entrance of the convergent cone 2. The penetration of the auxiliary passages 3 and the lobe passages 8 are seen end-on.

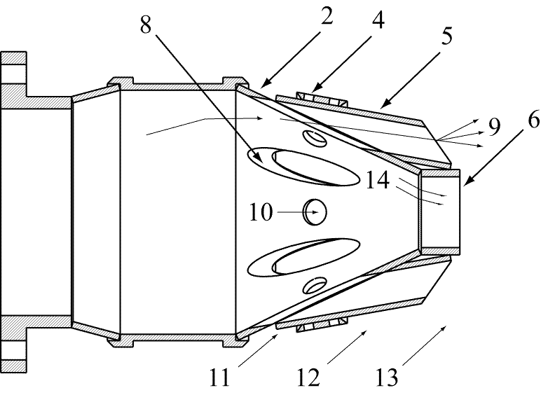

Section lines 4-4 leads to the primary section view of FIG. 4. The passage 8 is made in the axis formed by the lobe tube 5. The jet lobe 9 is then formed by the fluid flow.

The flow 10 from the auxiliary passages 3 illuminate the interior surface of the collar 4, which is at an angle to that flow. A suction created by the flow 10 induces a flow 11 to be admitted in the space between the main cone 2 and the collar 4. The flow 10 then ejects that flow into the converging space between the multi-lobe tubes 5. This induces a further in fall of fluid from the surrounding space 12 along the flow axis. The balance of the main flow 14 and the jet lobes 9 eject the ambient media 13.

1. A fluid ejector nozzle with a convergent core section and a plurality of intersecting convergent tubes forming secondary jet lobes radially disposed about the primary jet.

2. A fluid ejector nozzle as described in claim 1, wherein the exit ends of the said tubes are trimmed at an angle radially to the axis of the primary jet flow path.

3. A fluid ejector nozzle as described in claim 1, wherein a plurality of passages in the said core section between the secondary jet tubes creates an auxiliary flow stream radially disposed from the core body.

4. A fluid ejector nozzle as described in claim 3, wherein the said auxiliary flow stream is deflected downstream by a barrier.
